(19) United States
(12) Patent Application Publication
(10) Pub. No.: US 2026/0042462 A1
(43) Pub. Date: Feb. 12, 2026

(54) VEHICLE CONTROL METHOD AND POSITION RELIABILITY CALCULATION METHOD

(71) Applicant: TOYOTA JIDOSHA KABUSHIKI KAISHA, Toyota-shi (JP)

(72) Inventor: Hiroki FURUTA, Susono-shi (JP)

(73) Assignee: TOYOTA JIDOSHA KABUSHIKI KAISHA, Toyota-shi (JP)

(21) Appl. No.: 19/199,275

(22) Filed: May 5, 2025

(30) Foreign Application Priority Data
Aug. 7, 2024 (JP) 2024-131172

(51) Int. Cl. B60W 60/00

(52) U.S. Cl. CPC B60W 60/001; B60W 2422/70; B60W 2510/22; B60W 2556/20; B60W 2556/40

(57) ABSTRACT

Position information of a target vehicle is acquired based on a measurement result by a sensor mounted on the target vehicle, and includes a horizontal position and a vertical position of the target vehicle. A position reliability calculation method of calculating a reliability of the position information of the target vehicle includes: (A) acquiring an altitude of a representative point at the horizontal position of the target vehicle as a sensor-based altitude based on the vertical position included in the position information, (B) acquiring the altitude of the representative point at the horizontal position of the target vehicle as a map-based altitude based on an altitude map indicating a correspondence relationship between a latitude, a longitude, and an altitude of a road surface, and (C) calculating the reliability such that the reliability decreases as a deviation between the sensor-based altitude and the map-based altitude increases.

### CROSS-REFERENCE TO RELATED APPLICATION

This application claims priority to Japanese Patent Application No. 2024-131172 filed on Aug. 7, 2024. The disclosure of the above-identified application, including the specification, drawings, and claims, is incorporated by reference herein in its entirety.

### BACKGROUND

### 1. Technical Field

The present disclosure relates to vehicle control using position information of a vehicle. The present disclosure also relates to a technology for calculating a reliability of position information of a vehicle.

### 2. Description of Related Art

US 2018/0154723 A1 discloses a road surface displacement map representing a correspondence relationship between a road surface displacement (unevenness of a road surface) and a position. Vibration damping control is performed by using such a road surface displacement map. Specifically, a road surface displacement at a predetermined position in front of a vehicle is recognized in advance from the road surface displacement map. A control amount of an active suspension is calculated in advance according to the road surface displacement that has been recognized in advance. Then, by controlling the active suspension at a timing when wheels pass through the predetermined position, the vibration of the vehicle is effectively suppressed.

### SUMMARY

Vehicle control using position information of a vehicle is considered. In general, the position information of the vehicle is acquired based on a measurement result by a sensor mounted on the vehicle. In a case where accuracy of the position information of the vehicle is low, accuracy of the vehicle control using the position information may decrease. Therefore, when the vehicle control using the position information of the vehicle is performed, it is preferable to know how reliable the position information is. Therefore, it is desired to calculate a reliability of the position information of the vehicle.

An object of the present disclosure is to provide a technology capable of calculating a reliability of position information of a vehicle.

Another object of the present disclosure is to provide a technology capable of performing vehicle control using position information of a vehicle in consideration of a reliability of the position information.

A first aspect of the present disclosure relates to a vehicle control method of controlling a target vehicle.
The vehicle control method includes:
acquiring position information including a horizontal position and a vertical position of the target vehicle, based on a measurement result by a sensor mounted on the target vehicle;
calculating a reliability of the position information; and
executing position-use vehicle control that is control of the target vehicle using the position information in consideration of the reliability of the position information.
The calculating of the reliability of the position information includes
acquiring an altitude of a representative point at the horizontal position of the target vehicle as a sensor-based altitude, based on the vertical position included in the position information, acquiring an altitude of the representative point at the horizontal position of the target vehicle as a map-based altitude, based on an altitude map indicating a correspondence relationship between a latitude, a longitude, and an altitude of a road surface, and
calculating the reliability such that the reliability decreases as a deviation between the sensor-based altitude and the map-based altitude increases.

A second aspect of the present disclosure relates to a position reliability calculation method of calculating a reliability of position information of a target vehicle by a computer. The position information is acquired based on a measurement result by a sensor mounted on the target vehicle and includes a horizontal position and a vertical position of the target vehicle.
The position reliability calculation method includes:
acquiring an altitude of a representative point at the horizontal position of the target vehicle as a sensor-based altitude based on the vertical position included in the position information;
acquiring an altitude of the representative point at the horizontal position of the target vehicle as a map-based altitude based on an altitude map indicating a correspondence relationship between a latitude, a longitude, and an altitude of a road surface; and
calculating the reliability such that the reliability decreases as a deviation between the sensor-based altitude and the map-based altitude increases.

According to the first aspect, it is possible to perform the vehicle control using the position information of the vehicle in consideration of the reliability of the position information.

According to the second aspect, it is possible to calculate the reliability of the position information of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing a configuration example of a vehicle according to an embodiment;

FIG. 2 is a conceptual diagram showing a configuration example of a suspension according to the embodiment;

FIG. 3 is a flowchart showing an example of unsprung displacement calculation processing according to the embodiment;

FIG. 4 is a block diagram showing a configuration example of a vehicle control system according to the embodiment;

FIG. 5 is a block diagram showing an example of the driving environment information according to the embodiment;

FIG. 6 is a block diagram showing a configuration example of a map management system according to the embodiment;

FIG. 7 is a conceptual diagram for describing a unsprung displacement map according to the embodiment;

FIG. 8 is a flowchart schematically showing map generation/update processing according to the embodiment;

FIG. 9 is a conceptual diagram for describing a preview control using an unsprung displacement map according to the embodiment;

FIG. 10 is a flowchart showing a preview control using the unsprung displacement map according to the embodiment;

FIG. 11 is a conceptual diagram for describing a calculation method of a position reliability according to the embodiment;

FIG. 12 is a flowchart showing processing related to the position-use vehicle control according to the embodiment;

FIG. 13A is a conceptual diagram for describing an example of preview control according to the position reliability according to the embodiment;

FIG. 13B is a conceptual diagram for describing another example of the preview control according to the position reliability according to the embodiment;

FIG. 13C is a conceptual diagram for describing another example of the preview control according to the position reliability according to the embodiment;

FIG. 14A is a conceptual diagram for describing another example of the preview control according to the position reliability according to the embodiment;

FIG. 14B is a conceptual diagram for describing another example of the preview control according to the position reliability according to the embodiment;

FIG. 14C is a conceptual diagram for describing another example of the preview control according to the position reliability according to the embodiment;

FIG. 15 is a conceptual diagram for describing an example of autonomous driving control according to the position reliability according to the embodiment; and

FIG. 16 is a flowchart showing a map generation/update process considering the position reliability according to the embodiment.

### DETAILED DESCRIPTION OF EMBODIMENTS

Embodiments of the present disclosure will be described with reference to the accompanying drawings.

### 1. Suspension and Vertical Motion Parameter

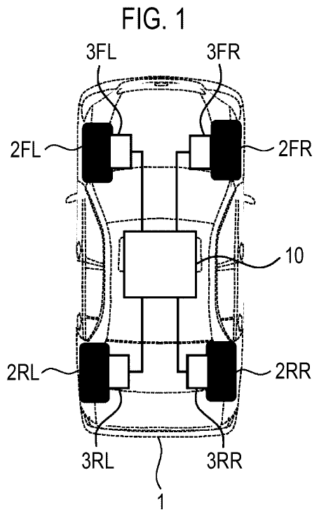

FIG. 1 is a schematic view showing a configuration example of a vehicle 1 according to the present embodiment. The vehicle 1 includes wheels 2 and suspensions 3. The wheels 2 include a front left wheel 2FL, a front right wheel 2FR, a rear left wheel 2RL, and a rear right wheel 2RR. Suspensions 3FL, 3FR, 3RL, and 3RR are provided for each of the front left wheel 2FL, the front right wheel 2FR, the rear left wheel 2RL, and the rear right wheel 2RR. In the following description, unless otherwise specified, each wheel is referred to as a wheel 2, and each suspension is referred to as a suspension 3.

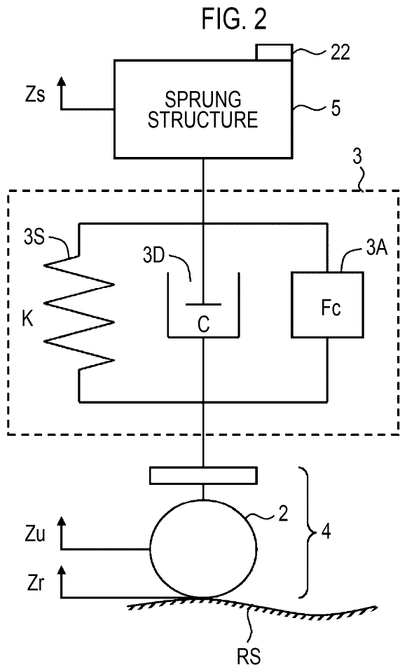

FIG. 2 is a conceptual diagram showing a configuration example of the suspension 3. The suspension 3 is provided to connect the unsprung structure 4 and the sprung structure 5 of the vehicle 1. The unsprung structure 4 includes the wheels 2. The suspension 3 includes a spring 3S, a damper (shock absorber) 3D, and an actuator 3A. The spring 3S, the damper 3D, and the actuator 3A are provided in parallel between the unsprung structure 4 and the sprung structure 5. The spring constant of the spring 3S is K. The damping coefficient of the damper 3D is C. The damping force of the damper 3D may be variable. The actuator 3A applies a control force Fc in the vertical direction between the unsprung structure 4 and the sprung structure 5.

Here, the definition of terms will be made. The “road surface displacement Zr” is a displacement of the road surface RS in the vertical direction. The “unsprung displacement Zu” is a displacement of the unsprung structure 4 in the vertical direction. The “sprung displacement Zs” is a displacement of the sprung structure 5 in the vertical direction. The “unsprung speed Zu” is the speed of the unsprung structure 4 in the vertical direction. The “spring speed Zs” is a speed in the vertical direction of the sprung structure 5. The “vertical spring acceleration Zu” is the acceleration in the vertical direction of the unsprung structure 4. The “vertical acceleration Zs” is the acceleration in the vertical direction of the sprung structure 5. The sign of each parameter is positive in an upward direction and negative in a downward direction.

The wheels 2 move on a road surface RS. In the following description, a parameter related to the vertical motion of the wheel 2 is referred to as a “vertical motion parameter”. Examples of the vertical motion parameter include the road surface displacement Zr, the unsprung displacement Zu, the unsprung speed Zu′, the unsprung acceleration Zu″, the sprung displacement Zs, the sprung speed Zs′, and the sprung acceleration Zs″. The vertical motion parameter can also be referred to as a “road surface displacement-related parameter” related to the road surface displacement Zr.

As an example, in the following description, a case where the vertical motion parameter is the unsprung displacement Zu will be considered. In a case of generalization, the “unsprung displacement” in the following description is replaced with the “vertical motion parameter”.

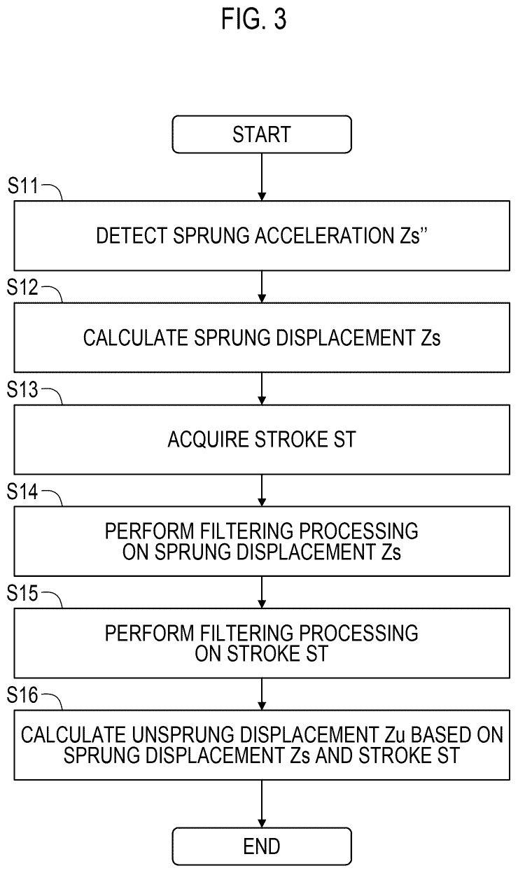

FIG. 3 is a flowchart showing an example of the unsprung displacement calculation process.

In S11, the sprung acceleration Zs″ is detected by the sprung acceleration sensor 22 installed in the sprung structure 5. In S12, the sprung displacement Zs of the vehicle body is calculated by performing double integration on the sprung acceleration Zs″ of the vehicle body.

In S13, a stroke ST (=Zs−Zu) that is a relative displacement between the sprung structure 5 and the unsprung structure 4 is acquired. For example, the stroke ST is detected by a stroke sensor installed in the suspension 3. As another example, the stroke ST may be estimated based on the sprung acceleration Zs″ by an observer configured based on the single-wheel two-degree-of-freedom model.

In S14, filtering processing is performed on the time-series data of the sprung displacement Zs in order to suppress the influence of the sensor drift and the like. Similarly, in S15, the filtering process is performed on the time-series data of the stroke ST. For example, the filter is a band-pass filter that allows a signal component in a specific frequency band to pass. The specific frequency band may be set to include the sprung resonance frequency of the vehicle 1. For example, the specific frequency band is 0.3 to 10 Hz.

In S16, a difference between the sprung displacement Zs and the stroke ST is calculated as an unsprung displacement Zu.

Instead of S14 and S15, filtering processing may be performed on the time-series data of the unsprung displacement Zu calculated in S16.

As still another example, the unsprung acceleration Zu″ may be detected by the unsprung acceleration sensor, and the unsprung displacement Zu may be calculated from the unsprung acceleration Zu″.

### 2. Vehicle Control System

### 2-1. Configuration Example

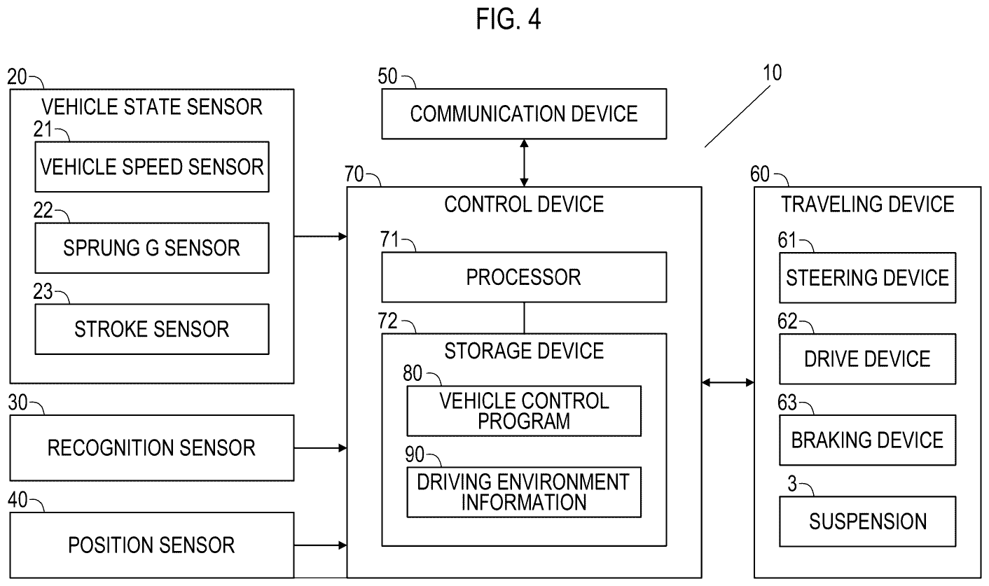

FIG. 4 is a block diagram showing a configuration example of the vehicle control system 10 according to the present embodiment. The vehicle control system 10 is applied to the vehicle 1 and controls the vehicle 1. For example, the vehicle control system 10 is mounted on the vehicle 1. As another example, the vehicle control system 10 may be distributed to the vehicle 1 and the remote device. The vehicle control system 10 includes a vehicle state sensor 20, a recognition sensor 30, a position sensor 40, a communication device 50, a traveling device 60, and a control device 70.

The vehicle state sensor 20 is mounted on the vehicle 1 and detects a state of the vehicle 1. The vehicle state sensor 20 includes a vehicle speed sensor (wheel speed sensor) 21 that detects a vehicle speed V of the vehicle 1, a sprung acceleration sensor 22 that detects a sprung acceleration Zs″, and the like. The vehicle state sensor 20 may include a stroke sensor 23 that detects a stroke ST. The vehicle state sensor 20 may include an unsprung acceleration sensor. The vehicle state sensor 20 includes a lateral acceleration sensor, a yaw rate sensor, a rudder angle sensor, and the like.

The recognition sensor 30 is mounted on the vehicle 1 and recognizes (detects) a situation around the vehicle 1. Examples of the recognition sensor include a camera, a laser imaging detection and ranging (LIDAR), and a radar.

The position sensor 40 is mounted on the vehicle 1 and includes a positioning device that detects the position and the orientation of the vehicle 1. For example, the position sensor 40 includes a global navigation satellite system (GNSS). For example, the position sensor 40 includes an RTK-GNSS.

The communication device 50 communicates with the outside of the vehicle 1.

The traveling device 60 includes a steering device 61, a drive device 62, a braking device 63, and a suspension 3 (see FIG. 2) mounted on the vehicle 1. The steering device 61 steers the wheels 2. The steering device 61 includes, for example, an electric power steering (EPS) device. The drive device 62 is a power source that generates drive power. Examples of the drive device 62 include an engine, an electric motor, and an in-wheel motor. The braking device 63 generates a braking force.

The control device 70 is a computer that controls the vehicle 1. The control device 70 may be mounted on the vehicle 1 or may be partially included in the remote device. The control device 70 includes one or more processors 71 (hereinafter, simply referred to as the processor 71) and one or more storage devices 72 (hereinafter, simply referred to as the storage device 72). The processor 71 executes various types of processing. For example, the processor 71 includes a central processing unit (CPU). The processor 71 can also be referred to as processing circuitry. The storage device 72 stores various information needed for processing by the processor 71. Examples of the storage device 72 include a volatile memory, a non-volatile memory, a hard disk drive (HDD), and a solid state drive (SSD). The control device 70 may include one or more electronic control units (ECUs).

The vehicle control program 80 is a computer program for controlling the vehicle 1, and is executed by the processor 71. The vehicle control program 80 is stored in the storage device 72. Alternatively, the vehicle control program 80 may be recorded on a computer-readable recording medium. The processor 71 executes the vehicle control program 80, whereby the function of the control device 70 is realized.

### 2-2. Driving Environment Information

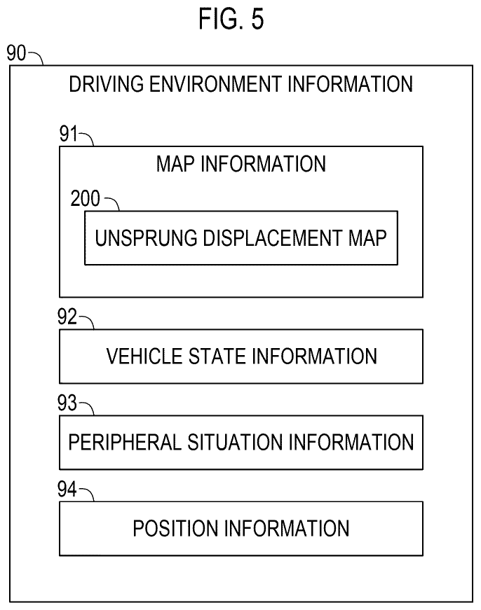

FIG. 5 is a block diagram showing an example of driving environment information 90 indicating a driving environment of the vehicle 1. The driving environment information 90 is stored in the storage device 72. The driving environment information 90 includes map information 91, vehicle state information 92, peripheral situation information 93, and position information 94.

The map information 91 includes a general navigation map. The map information 91 may indicate lane disposition, road shape, and the like. The map information 91 may include position information such as a white line, a traffic light, a sign, and a landmark. The map information 91 is obtained from a map database. The map database may be mounted on the vehicle 1 or may be stored in an external management server. In the latter case, the control device 70 communicates with the management server to acquire the needed map information 91.

The map information 91 further includes a “unsprung displacement map 200”. The details of the unsprung displacement map 200 will be described later.

The vehicle state information 92 is information indicating a state of the vehicle 1. The control device 70 acquires the vehicle state information 92 from the vehicle state sensor 20. For example, the vehicle state information 92 includes a vehicle speed V, a sprung mass acceleration Zs″, a stroke ST, a lateral acceleration, a yaw rate, a steering angle, and the like. The vehicle speed V may be calculated from the vehicle position detected by the position sensor 40. The control device 70 may calculate the unsprung displacement Zu by the method shown in FIG. 3. In this case, the vehicle state information 92 also includes the unsprung displacement Zu calculated by the control device 70.

The peripheral situation information 93 is information indicating a situation around the vehicle 1. The control device 70 recognizes the situation around the vehicle 1 by using the recognition sensor 30 and acquires the peripheral situation information 93. For example, the peripheral situation information 93 includes image information captured by a camera. As another example, the peripheral situation information 93 includes the point group information obtained by the LIDAR.

The peripheral situation information 93 further includes “object information” regarding an object around the vehicle 1. Examples of the object include a pedestrian, a bicycle, another vehicle (a preceding vehicle, a parked vehicle, and the like), a road configuration (a white line, a curb, a guardrail, a wall, a median strip, a roadside structure, and the like), a sign, a pole, an obstacle, and the like. The object information indicates a relative position and a relative speed of the object with respect to the vehicle 1. For example, the object can be identified and the relative position of the object can be calculated by analyzing the image information obtained by the camera. Further, the object can be identified and the relative position and the relative speed of the object can be acquired based on the point group information obtained by the LIDAR.

The position information 94 is information indicating the position and the orientation of the vehicle 1. The position includes a horizontal position and a vertical position. For example, the horizontal position is defined by latitude and longitude. The vertical position is defined by the altitude (elevation). Examples of the altitude include the sea level, the geoid height, and the ellipsoid height. The control device 70 acquires the position information 94 based on the measurement result by the position sensor 40 such as the GNSS. As another example, the control device 70 may acquire the position information 94 by dead reckoning. As still another example, the control device 70 may acquire high-precision position information 94 by well-known self-position estimation processing (localization) using the object information and the map information 91.

### 2-3. Vehicle Control

The control device 70 executes a vehicle traveling control for controlling traveling of the vehicle 1. The vehicle traveling control includes steering control, drive control, and braking control. The control device 70 executes the vehicle traveling control by controlling the traveling device 60 (the steering device 61, the drive device 62, and the braking device 63). The control device 70 may execute driving assistance control for assisting driving of the vehicle 1 based on the driving environment information 90. Examples of the driving assistance control include a lane keeping control, a collision avoidance control, and an autonomous driving control.

The control device 70 controls the suspension 3. Typically, the control device 70 performs a vibration suppression control of controlling the suspension 3 to suppress the vibration of the vehicle 1. For example, the control device 70 controls the actuator 3A to generate the control force Fc in the vertical direction between the unsprung structure 4 and the sprung structure 5 (see FIG. 2). As another example, the control device 70 may variably control the damping force of the damper 3D. The vibration suppression control includes “preview control” described later.

### 3. Map Management System

### 3-1. Configuration Example

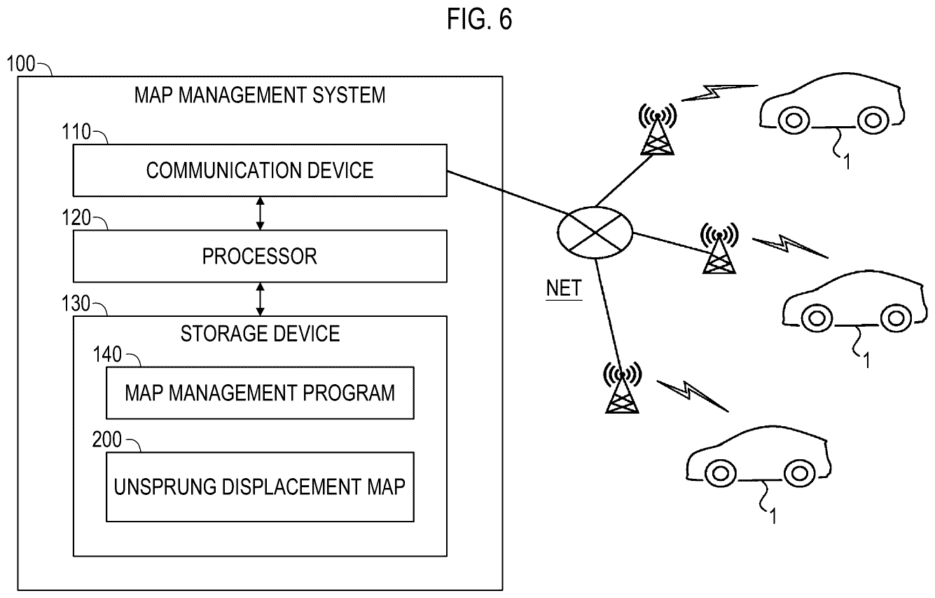

FIG. 6 is a block diagram showing a configuration example of a map management system 100 according to the present embodiment. The map management system 100 is a computer that manages various pieces of map information. The management of the map information includes the generation, update, provision, distribution, and the like of the map information. Typically, the map management system 100 is a management server on the cloud. The map management system 100 may be a distributed system in which a plurality of servers performs distributed processing.

The map management system 100 includes a communication device 110. The communication device 110 is connected to a communication network NET. For example, the communication device 110 communicates with a large number of vehicles 1 via the communication network NET.

The map management system 100 further includes one or more processors 120 (hereinafter, simply referred to as processor 120) and one or more storage devices 130 (hereinafter, simply referred to as storage device 130). The processor 120 executes various kinds of information processing. For example, the processor 120 includes a CPU. The processor 120 can also be referred to as processing circuitry. The storage device 130 stores various pieces of map information. The storage device 130 stores various information needed for processing by the processor 120. Examples of the storage device 130 include a volatile memory, a non-volatile memory, an HDD, and an SSD.

The map management program 140 is a computer program for map management, and is executed by the processor 120. The map management program 140 is stored in the storage device 130. Alternatively, the map management program 140 may be recorded on a computer-readable recording medium. The processor 120 executes the map management program 140 to realize the functions of the map management system 100.

The processor 120 communicates with the vehicle control system 10 of the vehicle 1 via the communication device 110. The processor 120 collects various pieces of information from the vehicle control system 10, and generates and updates map information based on the collected information. In addition, the processor 120 distributes the map information to the vehicle control system 10. The processor 120 provides the map information in response to a request from the vehicle control system 10.

### 3-2. Unsprung Displacement Map

One of the pieces of map information managed by the map management system 100 is a “unsprung displacement map (vertical motion parameter map) 200”. The unsprung displacement map 200 is a map regarding the unsprung displacement Zu (vertical motion parameter), and shows a correspondence relationship between the unsprung displacement Zu (vertical motion parameter) and the position. The unsprung displacement map 200 is stored in the storage device 130.

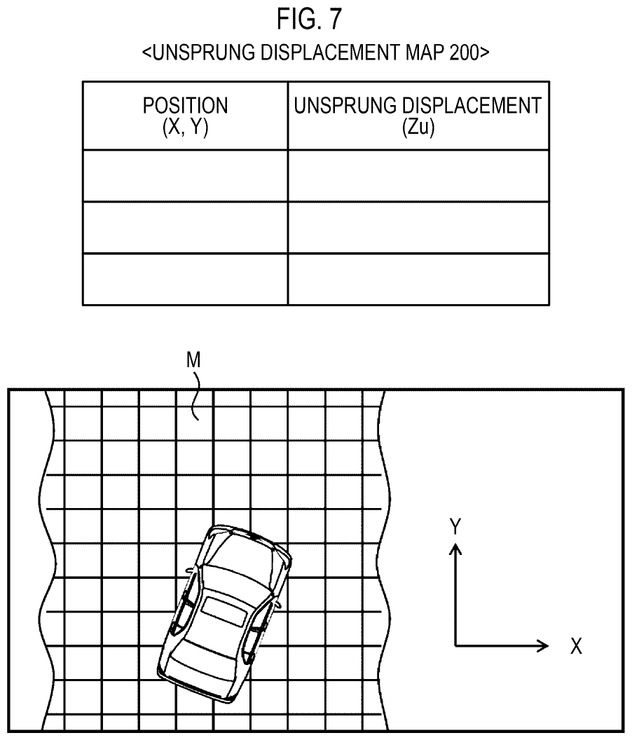

FIG. 7 is a conceptual diagram for describing an unsprung displacement map 200. An XY plane represents a horizontal plane. For example, the absolute coordinate system in the horizontal plane is defined by the latitude direction and the longitude direction, and the horizontal position is defined by the latitude and the longitude. The unsprung displacement map 200 represents at least a correspondence relationship between the horizontal position (X, Y) and the unsprung displacement Zu. In other words, the unsprung displacement map 200 represents the unsprung displacement Zu as a function of at least the horizontal position (X, Y).

The road area may be divided into a mesh shape on a horizontal plane. That is, the road area may be divided into a plurality of unit areas M on the horizontal plane. The unit area M is, for example, a square. The length of one side of the square is, for example, 10 cm. The unsprung displacement map 200 represents the correspondence relationship between the position of the unit area M and the unsprung displacement Zu. The position of the unit area M may be defined by a representative position (for example, a center position) of the unit area M or may be defined by a range (latitude range, longitude range) of the unit area M. The unsprung displacement Zu of the unit area M is, for example, an average value of the unsprung displacement Zu acquired in the unit area M. As the unit area M is reduced, the resolution of the unsprung displacement map 200 is increased.

### 3-3. Map Generation/Update Processing

The processor 120 collects information from a large number of vehicles 1 via the communication device 110. Then, the processor 120 generates and updates the unsprung displacement map 200 based on the information collected from the vehicles 1. Hereinafter, an example of the map generation/update process will be described in more detail.

The position in the unsprung displacement map 200 is a position where the wheels 2 pass. The position of each wheel 2 is calculated based on the position information 94. Specifically, the relative positional relationship between the reference point of the vehicle position in the vehicle 1 and each of the wheels 2 is known information. The position of each wheel 2 can be calculated based on the relative positional relationship and the vehicle position indicated by the position information 94.

The unsprung displacement Zu is calculated by the method as shown in FIG. 3. That is, the sprung displacement Zs or the stroke ST can be obtained by using the vehicle state sensor 20 mounted on the vehicle 1. The sprung displacement Zs and the stroke ST are referred to as “sensor-based information” for convenience. The unsprung displacement Zu is calculated based on the sensor base information.

For example, during traveling of the vehicle 1, the control device 70 of the vehicle control system 10 calculates the unsprung displacement Zu in real time based on the sensor-based information. In addition, the control device 70 associates the wheel position and the unsprung displacement Zu at the same timing. Then, the control device 70 transmits a set of the time-series data of the wheel position and the time-series data of the unsprung displacement Zu to the map management system 100. The processor 120 of the map management system 100 generates and updates the unsprung displacement map 200 based on the time-series data of the wheel position and the time-series data of the unsprung displacement Zu.

As another example, the control device 70 of the vehicle control system 10 associates the wheel position and the sensor base information at the same timing. The control device 70 transmits a set of the time-series data of the wheel position and the time-series data of the sensor-based information to the map management system 100. The processor 120 of the map management system 100 calculates the unsprung displacement Zu based on the received sensor-based information. Further, the processor 120 generates and updates the unsprung displacement map 200 based on the time-series data of the wheel position and the time-series data of the unsprung displacement Zu.

In a case where the unsprung displacement Zu is calculated in the map management system 100, there is no constraint on the processing time, and thus the filtering process can be performed using the zero phase filter. By using the zero phase filter, “phase shift” can be prevented.

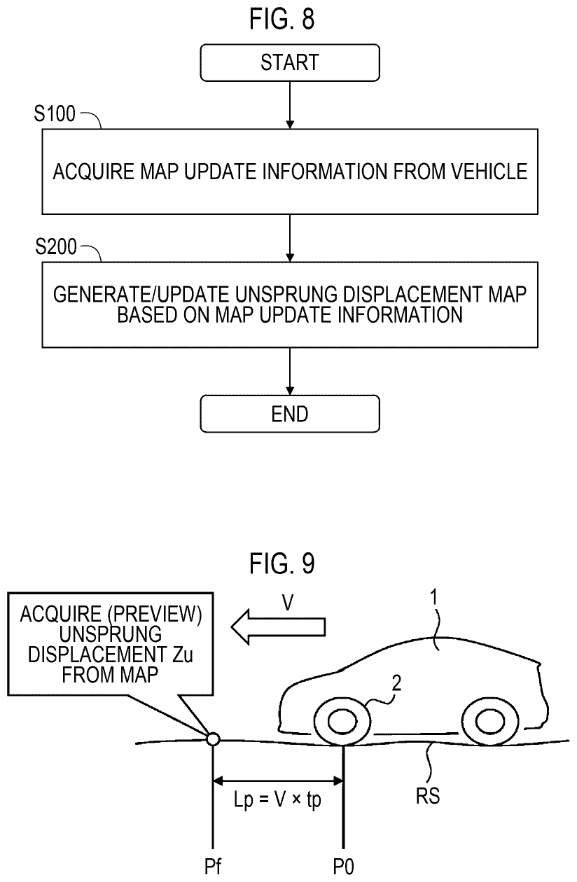

FIG. 8 is a flowchart schematically showing map generation/update processing according to the present embodiment.

In S100, the processor 120 of the map management system 100 acquires the “map update information” from the vehicle 1 (vehicle control system 10) via the communication device 110. The map update information includes time-series data of the position (wheel position) of the vehicle 1. The map update information includes time-series data of sensor-based information (for example, the sprung displacement Zs and the stroke ST) needed to calculate the unsprung displacement Zu. Alternatively, the map update information may include the time-series data of the unsprung displacement Zu calculated by the control device 70 of the vehicle control system 10.

In S200, the processor 120 of the map management system 100 generates/updates the unsprung displacement map 200 based on the map update information.

### 3-4. Modification Example

The vehicle control system 10 of the vehicle 1 may hold the database of the unsprung displacement map 200 and generate/update the unsprung displacement map 200 of the vehicle 1. That is, the map management system 100 may be included in the vehicle control system 10.

### 4. Preview Control Using Unsprung Displacement Map

The control device 70 of the vehicle control system 10 performs communication with the map management system 100 via the communication device 50. The control device 70 acquires the unsprung displacement map 200 of the area including the current position of the vehicle 1 from the map management system 100. The unsprung displacement map 200 is stored in the storage device 72. Then, the control device 70 executes “preview control” that is a kind of vibration damping control based on the unsprung displacement map 200.

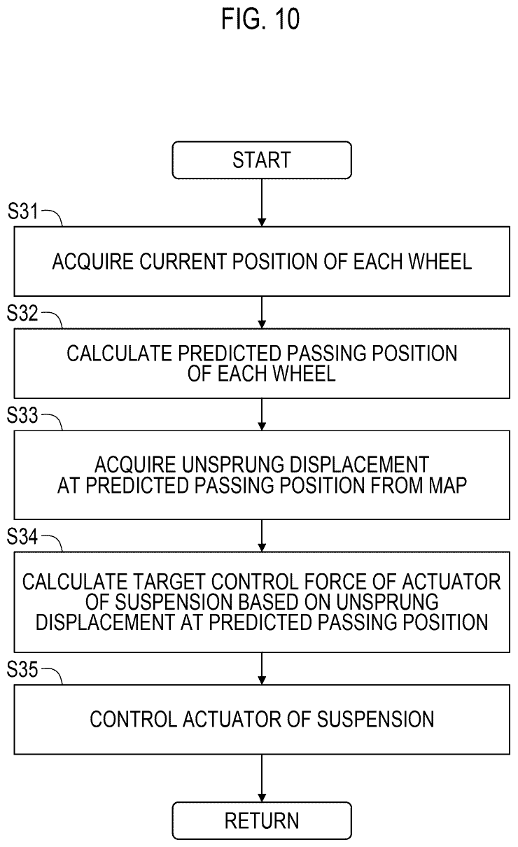

FIG. 9 is a conceptual diagram for describing the preview control. FIG. 10 is a flowchart showing the preview control. The preview control will be described with reference to FIGS. 9 and 10.

In S31, the control device 70 acquires the current position PO of each wheel 2. A relative positional relationship between a reference point of a vehicle position in the vehicle 1 and each of the wheels 2 is known information. The position of each wheel 2 can be calculated based on the relative positional relationship and the vehicle position indicated by the position information 94.

In S32, the control device 70 calculates the predicted passing position Pf of the wheels 2 after the preview time tp. The preview time tp is set to be, for example, longer than the time needed for the calculation processing or the communication processing needed to operate the actuator 3A of the suspension 3. The preview time tp may be fixed or may be variable according to the situation. The preview distance Lp is given by the product of the preview time tp and the vehicle speed V. The predicted passing position Pf is a position in front of the current position PO by the preview distance Lp. As a modification example, the control device 70 may calculate the predicted traveling route based on the vehicle speed V and the steering angle of the wheels 2, and calculate the predicted passing position Pf based on the predicted traveling route.

In S33, the control device 70 reads the unsprung displacement Zu at the predicted passing position Pf from the unsprung displacement map 200.

In S34, the control device 70 calculates the target control force Fc_t of the actuator 3A of the suspension 3 based on the unsprung displacement Zu at the predicted passing position Pf. The target control force Fc_t is calculated, for example, as follows.

The motion equation for the sprung structure 5 (see FIG. 2) is represented by the following equation (1).

$$\begin{matrix}Formula 1 & \\ m \cdot {Zs}^{″} = C ( {Zu}^{′} - Z {s}^{′} ) + K ( Z u \to Z s ) \to Fc & ( 1 )\end{matrix}$$

In Expression (1), m is the mass of the sprung structure 5, C is the damping coefficient of the damper 3D, K is the spring constant of the spring 3S, and Fc is the vertical control force Fc generated by the actuator 3A. Assuming that the vibration of the sprung structure 5 is completely canceled by the control force Fc (Zs′=0, Zs′=0, Zs=0), the control force Fc is represented by the following equation (2).

$$\begin{matrix}Formula 2 & \\ Fc \to C \cdot {Zu}^{′} + K \cdot Zu & ( 2 )\end{matrix}$$

At least the control force Fc that brings the vibration damping effect is represented by the following equation (3).

$$\begin{matrix}Formula 3 & \\ Fc = α \cdot C \cdot {Zu}^{′} + β \cdot K \cdot Zu & ( 3 )\end{matrix}$$

In Expression (3), the gain a is larger than 0 and equal to or smaller than 1, and the gain B is also larger than 0 and equal to or smaller than 1. When the differential term in equation (3) is omitted, at least the control force Fc that brings the vibration damping effect is represented by the following equation (4).

$$\begin{matrix}Formula 4 & \\ Fc = β \cdot K \cdot Zu & ( 4 )\end{matrix}$$

The control device 70 calculates the target control force Fc_t according to the equation (3) or (4). That is, the control device 70 substitutes the unsprung displacement Zu at the predicted passing position Pf into Expression (3) or Expression (4) to calculate the target control force Fc_t.

In S35, the control device 70 controls the actuator 3A to generate the target control force Fc_t at the timing when the wheels 2 pass through the predicted passing position Pf. The timing at which the wheels 2 pass through the predicted passing position Pf is known from the preview time tp.

With the preview control using the unsprung displacement map 200 described above, it is possible to effectively suppress the vibration of the vehicle 1 (sprung structure 5).

### 5. Reliability of Position Information

In the following description, the target of the control by the vehicle control system 10 (control device 70) is referred to as a “target vehicle IT” for convenience. In addition, the vehicle control using the position information 94 of the target vehicle IT is hereinafter referred to as “position-use vehicle control”. The above-described preview control using the position information 94 to calculate the position of the wheel 2 is an example of the position-use vehicle control.

When the accuracy of the position information 94 of the target vehicle IT is low, the accuracy of the position-use vehicle control may be reduced. Therefore, when the position-use vehicle control is performed, it is preferable to grasp (recognize) how much the position information 94 of the target vehicle IT can be trusted. Therefore, it is desired to calculate the reliability of the position information 94 of the target vehicle IT. The reliability of the position information 94 of the target vehicle IT is hereinafter referred to as “position reliability R”.

When the position reliability R of the position information 94 can be grasped, the content of the position-use vehicle control can be appropriately adjusted according to the position reliability R. For example, in a case where the position reliability R is low, the position-use vehicle control may be suppressed. However, when the accuracy (reliability) of the position reliability R itself is low, the accuracy of the position-use vehicle control is ultimately reduced, or the effect of the position-use vehicle control may be reduced. For example, when the position reliability R is determined to be high by mistake even though the position reliability R is actually low, the accuracy of the position-use vehicle control may be reduced. On the other hand, in a case where the position reliability R is actually high but is erroneously determined to be low, the position-use vehicle control is unnecessarily suppressed, and the effect thereof may not be sufficiently obtained. Therefore, it is also desired to increase the calculation accuracy (reliability) of the position reliability R itself.

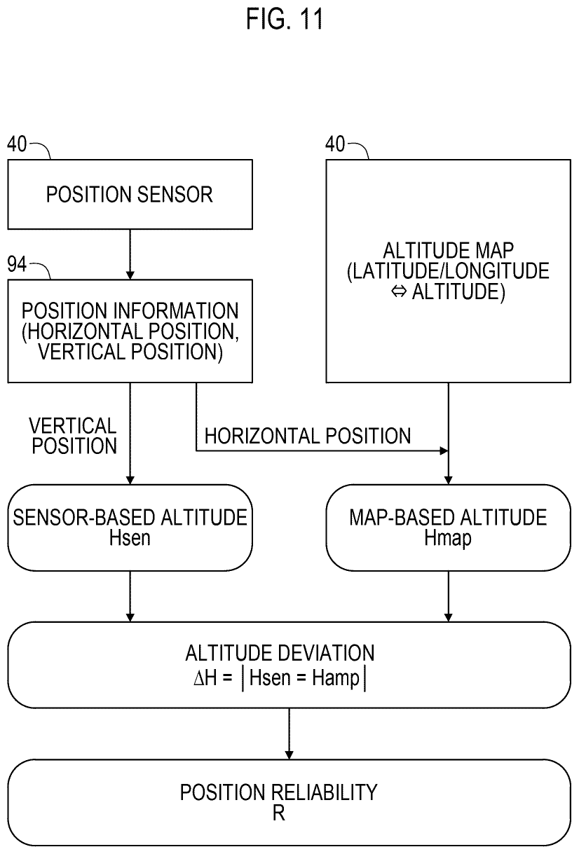

FIG. 11 is a conceptual diagram for describing a calculation method of the position reliability R according to the present embodiment.

As described above, the position information 94 of the target vehicle IT is obtained based on the measurement result by the position sensor 40 mounted on the target vehicle IT. The position information 94 includes a horizontal position and a vertical position of the target vehicle IT. For example, the horizontal position is defined by latitude and longitude. The vertical position is defined by the altitude (elevation). Examples of the altitude include the sea level, the geoid height, and the ellipsoid height.

The horizontal position and the vertical position of the target vehicle IT more accurately mean the horizontal position and the vertical position of a “vehicle reference point” that moves together with the target vehicle IT. The vehicle reference point of the target vehicle IT is optional. For example, the vehicle reference point of the target vehicle IT may be the center point of the target vehicle IT or the mounting position of the position sensor 40. A design value (default value) of a relative height of the vehicle reference point from the road surface is given as known information. Further, the relative height of the vehicle reference point from the road surface may be corrected from the design value in consideration of the stroke ST of the suspension 3, the inclination of the vehicle body (roll angle, pitch angle), the tire deflection, and the like. In any case, the relative height from the road surface of the vehicle reference point is obtained. The control device 70 can convert the vertical position of the target vehicle IT into the altitude of the road surface based on the relative height from the road surface of the vehicle reference point. Similarly, the control device 70 can convert the altitude of the road surface into the vertical position of the target vehicle IT based on the relative height from the road surface of the vehicle reference point.

The control device 70 of the vehicle control system 10 acquires the altitude of the “representative point P” at the horizontal position of the target vehicle IT. For example, the representative point P is a road surface. As another example, the representative point P may be a point separated from the road surface by a certain height. As still another example, the representative point P may be a vehicle reference point of the target vehicle IT. As described above, the altitude of the road surface and the vertical position of the vehicle reference point can be converted into each other. Therefore, when the altitude of the road surface or the vertical position of the vehicle reference point is known, the altitude of the representative point P can be calculated.

According to the present embodiment, the control device 70 acquires the altitude of the representative point P at the horizontal position of the target vehicle IT by two different methods.

A first method uses the position information 94 of the target vehicle IT. The control device 70 acquires the altitude of the representative point P in the horizontal position of the target vehicle IT based on the vertical position of the target vehicle IT (vehicle reference point) included in the position information 94. As described above, when the vertical position of the vehicle reference point is known, the altitude of the representative point P can be calculated. The altitude of the representative point P obtained based on the position information 94 is hereinafter referred to as “sensor-based altitude Hsen”.

A second method uses an altitude map 400 indicating a correspondence relationship between the latitude, the longitude, and the altitude of the road surface (ground). Examples of the altitude include the sea level, the geoid height, and the ellipsoid height. For example, map data issued by the Geospatial Information Authority of Japan may be used as the altitude map 400. The altitude map 400 is a kind of the map information 91 and is stored in the storage device 72 in advance. The control device 70 reads the altitude of the road surface at the horizontal position of the target vehicle IT from the altitude map 400. Further, the control device 70 calculates the altitude of the representative point P based on the altitude of the road surface read from the altitude map 400. The altitude of the representative point P obtained based on the altitude map 400 is hereinafter referred to as “map-based altitude Hmap”.

Next, the control device 70 calculates the altitude deviation ΔH (=|Hsen−Hmap|) between the sensor-based altitude Hsen and the map-based altitude Hmap with respect to the representative point P at the same horizontal position. Then, the control device 70 calculates the position reliability R of the position information 94 based on the altitude deviation ΔH. As the high degree of altitude deviation ΔH is smaller, the position reliability R is higher. On the contrary, as the altitude deviation ΔH is larger, the position reliability R is lower.

As described above, according to the present embodiment, it is possible to calculate the position reliability R of the position information 94 of the target vehicle IT. In particular, by referring to the altitude map 400, which is the correct answer data, it is possible to calculate the position reliability R of the position information 94 with high accuracy.

As a comparative example, an algorithm for position estimation in GNSS or the like may be considered to estimate the reliability of the position estimation process and output the reliability. However, the reliability of the position estimation processing is merely estimated based on the internal parameters in the position estimation processing, and is not based on correct answer data. The accuracy of the reliability estimated by the position estimation algorithm is lower than the accuracy of the position reliability R obtained by referring to the altitude map 400, which is the correct answer data.

### 6. Position-Use Vehicle Control Considering Position Reliability

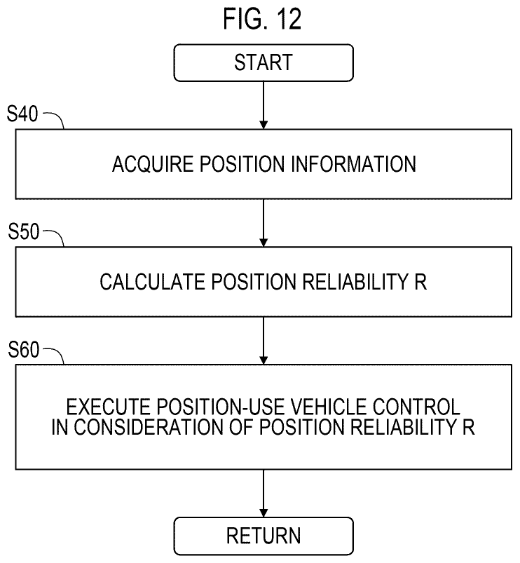

FIG. 12 is a flowchart showing processing related to the position-use vehicle control according to the present embodiment. In S40, the control device 70 of the vehicle control system 10 acquires the position information 94 of the target vehicle IT. In S50, the control device 70 calculates the position reliability R of the position information 94. The calculation method of the position reliability R is as described in the above Section 5.

In S60, the control device 70 executes the position-use vehicle control in consideration of the position reliability R. More specifically, the control device 70 flexibly adjusts the “degree” of the position-use vehicle control according to the position reliability R. The degree of the position-use vehicle control is represented by, for example, a gain of the position-use vehicle control. The higher the gain of the position-use vehicle control, the higher the degree of the position-use vehicle control.

For example, the control device 70 may reduce the degree of the position-use vehicle control as the position reliability R is lower. On the contrary, the control device 70 may increase the degree of the position-use vehicle control as the position reliability R is higher. In general, the following is as follows. As the position reliability R, a first position reliability R1 and a second position reliability R2 lower than the first position reliability R1 (R1>R2) are considered. The control device 70 reduces the degree of the position-use vehicle control in a case where the second position reliability R2 is set, as compared with the degree of the position-use vehicle control in a case where the first position reliability R1 is set. As a result, it is possible to suppress the inappropriate execution of the position-use vehicle control in a case where the position reliability R is low. In addition, when the position reliability R is high, it is possible to effectively perform the position-use vehicle control.

Hereinafter, a specific example of the position-use vehicle control in consideration of the position reliability R will be described.

### 6-1. First Example: Preview Control

In the first example, the position-use vehicle control is the preview control. In the preview control, the position information 94 is used to acquire the position of the wheels 2. For example, when the position reliability R of the position information 94 is low, the accuracy of the position of the wheels 2 is low. When the accuracy of the position of the wheel 2 is low, the unsprung displacement Zu read from the unsprung displacement map 200 may deviate from the unsprung displacement Zu at the actual position of the wheel 2. This may cause a decrease in the effect of the preview control and may sometimes cause vibration instead of vibration damping.

Therefore, the control device 70 flexibly adjusts the gain of the preview control in accordance with the position reliability R of the position information 94. For example, the gain of the preview control is β in the equation (4).

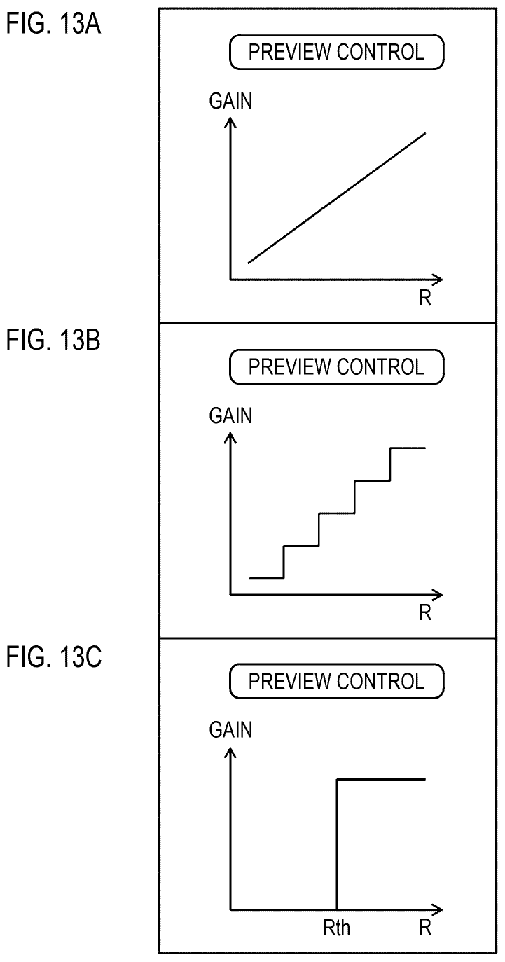

FIGS. 13A, 13B, and 13C are conceptual diagrams for describing various examples of the preview control according to the position reliability R. The horizontal axis represents the position reliability R, and the vertical axis represents the gain of the preview control. In FIG. 13A, as the position reliability R decreases, the gain of the preview control decreases monotonically. In FIG. 13B, as the position reliability R decreases, the gain of the preview control is gradually decreased. In FIG. 13C, the preview control is executed when the position reliability R is equal to or greater than the threshold value Rth, and the preview control is not executed (gain=0) when the position reliability R is less than the threshold value Rth. In general, the following is as follows. As the position reliability R, a first position reliability R1 and a second position reliability R2 lower than the first position reliability R1 (R1>R2) are considered. The control device 70 sets the gain of the preview control in the case of the second position reliability R2 to be lower than the gain of the preview control in the case of the first position reliability R1. As a result, it is possible to suppress the inappropriate execution of the preview control in a case where the position reliability R is low. In addition, it is possible to effectively perform the preview control in a case where the position reliability R is high.

The vibration suppression control may be a combination of the preview control and the feedback control. In a case of a combination of the preview control and the feedback control, the control force Fc is represented by, for example, the following equation (5). Equation (5) corresponds to the right side of equation (4) to which a feedback term related to the feedback control is added. γ is a gain of the feedback control.

$$\begin{matrix}Formula 5 & \\ Fc = β \cdot K \cdot Zu + γ \cdot {Zs}^{′} & ( 5 )\end{matrix}$$

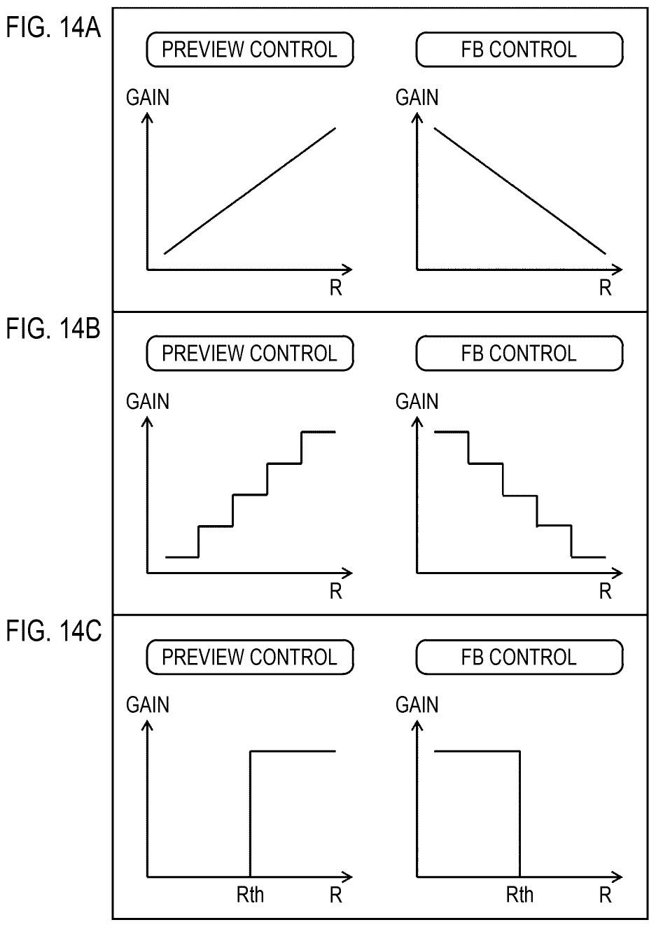

FIGS. 14A, 14B, and 14C show various examples in a case of a combination of the preview control and the feedback control. In FIG. 14A, as the position reliability R decreases, the gain of the preview control decreases monotonically, and instead, the gain of the feedback control increases monotonically. In FIG. 14B, as the position reliability R decreases, the gain of the preview control is gradually decreased, and instead, the gain of the feedback control is monotonically increased. In FIG. 14C, when the position reliability R is equal to or greater than the threshold value Rth, the preview control is executed, and when the position reliability R is less than the threshold value Rth, the feedback control is executed instead of the preview control. In general, the following is as follows. The control device 70 sets the gain of the preview control in the case of the second position reliability R2 to be lower than the gain of the preview control in the case of the first position reliability R1. The control device 70 sets the gain of the feedback control in the case of the second position reliability R2 to be higher than the gain of the feedback control in the case of the first position reliability R1. As a result, the preview control is suppressed from being inappropriately performed in a case where the position reliability R is low, and it is possible to supplement the effect of the vibration control by the feedback control.

A combination of the preview control and the rear preview control is also possible. In the rear preview control, it is assumed that the front wheels and the rear wheels of the target vehicle IT pass through the same position. First, when the front wheels pass through the first position, the unsprung displacement Zu of the spring is calculated in real time by the method shown in FIG. 3. For convenience, the unsprung displacement Zu is referred to as a front wheel unsprung displacement Zu_f. Thereafter, at the timing when the rear wheel passes through the first position, the preview control is performed using the front wheel unsprung displacement Zu_f calculated above instead of the unsprung displacement Zu of the spring lower limit value registered in the unsprung displacement map 200. In the rear preview control, the unsprung displacement Zu does not need to be read out from the unsprung displacement map 200, and thus the position information 94 is not used. That is, the rear preview control is not affected by the position reliability R. Therefore, the gain of the rear preview control may be changed in the same manner as the gains of the feedback control shown in FIGS. 14A, 14B, and 14C. As a result, in a case where the position reliability R is low, it is possible to supplement the effect of the vibration suppression control by the rear preview control.

### 6-2. Second Example: Autonomous Driving Control

The control device 70 of the vehicle control system 10 may execute autonomous driving control for controlling autonomous driving of the target vehicle IT. Here, autonomous driving means that at least a part of steering, acceleration, and deceleration of the target vehicle IT is automatically performed independently of the operation of the driver. As an example, autonomous driving of level 3 or higher may be performed. The control device 70 generates the traveling plan based on the driving environment information 90. Examples of the traveling plan include maintaining the current traveling lane, performing a lane change, performing a right or left turn, and avoiding a collision with an object. More specifically, the traveling plan includes a route plan and a speed plan. The route plan is a set of target positions of the target vehicle IT. The speed plan is a set of target speeds for each target position. The combination of the route plan and the speed plan is also referred to as a target trajectory. That is, the target trajectory includes the target position and the target speed of the target vehicle IT. The control device 70 performs the vehicle traveling control such that the target vehicle IT follows the target trajectory.

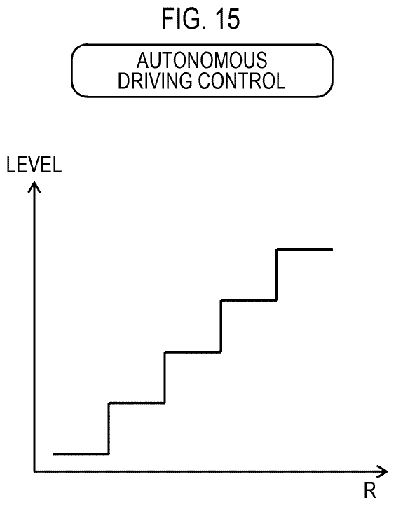

FIG. 15 is a conceptual diagram for describing an example of autonomous driving control according to the position reliability R. A horizontal axis represents a position reliability R, and a vertical axis represents a level of autonomous driving control (autonomous driving level). As shown in FIG. 15, as the position reliability R decreases, the level of the autonomous driving control decreases. In general, the following is as follows. As the position reliability R, a first position reliability R1 and a second position reliability R2 lower than the first position reliability R1 (R1>R2) are considered. The control device 70 sets the level of the autonomous driving control in the case of the second position reliability R2 to be lower than the level of the autonomous driving control in the case of the first position reliability R1. As a result, it is possible to suppress the autonomous driving control from being inappropriately performed in a case where the position reliability R is low. In addition, when the position reliability R is high, it is possible to execute the autonomous driving control at a high level.

### 7. Map Update

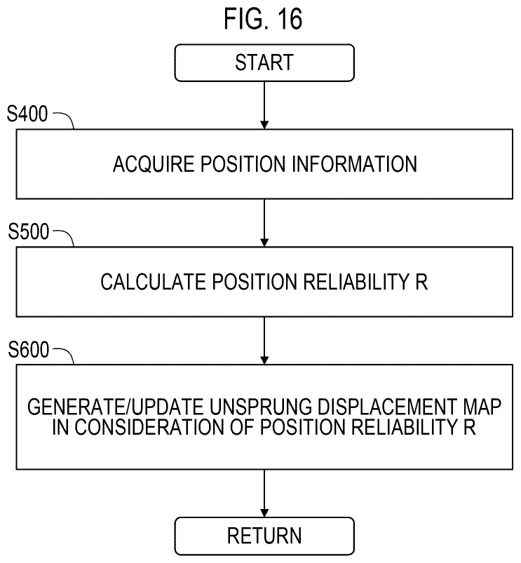

FIG. 16 is a flowchart showing a map generation/update process considering the position reliability R. In S400, the map management system 100 (see FIG. 6) acquires the position information 94 of the target vehicle IT. In S500, the map management system 100 calculates the position reliability R of the position information 94. The calculation method of the position reliability R is as described in the above Section 5. The altitude map 400 is stored in advance in the storage device 130 of the map management system 100.

In S600, the map management system 100 generates/updates the unsprung displacement map 200 by considering the position reliability R. For example, when the position reliability R is less than the threshold value, the map management system 100 does not generate/update the unsprung displacement map 200 for the position. The map management system 100 generates/updates the unsprung displacement map 200 for the position solely when the position reliability R is equal to or higher than the threshold value. As a result, it is possible to suppress a decrease in the accuracy of the unsprung displacement map 200.

What is claimed is:

1. A vehicle control method of controlling a target vehicle, the method comprising:
acquiring position information including a horizontal position and a vertical position of the target vehicle, based on a measurement result by a sensor mounted on the target vehicle;
calculating a reliability of the position information; and
executing position-use vehicle control that is control of the target vehicle using the position information in consideration of the reliability of the position information,
wherein the calculating of the reliability of the position information includes
acquiring an altitude of a representative point at the horizontal position of the target vehicle as a sensor-based altitude, based on the vertical position included in the position information,
acquiring an altitude of the representative point at the horizontal position of the target vehicle as a map-based altitude, based on an altitude map indicating a correspondence relationship between a latitude, a longitude, and an altitude of a road surface, and
calculating the reliability such that the reliability decreases as a deviation between the sensor-based altitude and the map-based altitude increases.

2. The vehicle control method according to claim 1, further comprising lowering a degree of the position-use vehicle control in a case where the reliability is a second reliability lower than a first reliability, compared to a degree of the position-use vehicle control in a case where the reliability is the first reliability.

3. The vehicle control method according to claim 1, wherein:
the position-use vehicle control includes preview control;
the preview control includes
acquiring a vertical motion parameter map indicating a correspondence relationship between a vertical motion parameter related to a vertical motion of a wheel of a vehicle and a position,
reading the vertical motion parameter at a position of a wheel of the target vehicle from the vertical motion parameter map based on the position information, and
controlling the target vehicle based on the vertical motion parameter read from the vertical motion parameter map; and
a gain of the preview control in a case where the reliability is a second reliability lower than a first reliability is set to be lower than a gain of the preview control in a case where the reliability is the first reliability.

4. The vehicle control method according to claim 1, wherein:
the position-use vehicle control includes autonomous driving control of the target vehicle; and
a level of the autonomous driving control in a case where the reliability is a second reliability lower than a first reliability is set to be lower than a level of the autonomous driving control in a case where the reliability is the first reliability.

5. A position reliability calculation method of calculating a reliability of position information of a target vehicle by a computer, in which the position information is acquired based on a measurement result by a sensor mounted on the target vehicle and includes a horizontal position and a vertical position of the target vehicle, the position reliability calculation method comprising:
acquiring an altitude of a representative point at the horizontal position of the target vehicle as a sensor-based altitude based on the vertical position included in the position information;
acquiring an altitude of the representative point at the horizontal position of the target vehicle as a map-based altitude based on an altitude map indicating a correspondence relationship between a latitude, a longitude, and an altitude of a road surface; and
calculating the reliability such that the reliability decreases as a deviation between the sensor-based altitude and the map-based altitude increases.
